(19) United States
(12) Patent Application Publication
(10) Pub. No.: US 2018/0145983 A1
(43) Pub. Date: May 24, 2018

(54) DISTRIBUTED DATA STORAGE SYSTEM USING A COMMON MANIFEST FOR STORING AND ACCESSING VERSIONS OF AN OBJECT

(71) Applicant: NEXENTA SYSTEMS, INC., Santa Clara, CA (US)

(72) Inventor: Caitlin BESTLER, Sunnyvale, CA (US)

(73) Assignee: NEXENTA SYSTEMS, INC., Santa Clara, CA (US)

(21) Appl. No.: 15/358,412

(22) Filed: Nov. 22, 2016

(51) Int. Cl. H04L 29/06; H04L 9/32

(52) U.S. Cl. CPC H04L 63/10; H04L 63/101; G06F 17/30094; H04L 63/08; H04L 9/3236

(57) ABSTRACT

The present disclosure provides a system and method to perform access control authentication using a cryptographic hash of the encoding of access control rules. The compact cryptographic hash identifier of the access control rules is suitable for inclusion in a name indexing entry, whereas inclusion of the full encoding would result in a large name indexing entry, resulting in disadvantageously large storage requirements and bandwidth usage. In accordance with an embodiment of the invention, a common manifest is used to store and access versions of a named object stored in a distributed data storage system. The common manifest for the named object may encode a set of key-value metadata pairs which have been inherited from a parent object, such as an enclosing folder, for example. Other embodiments, aspects and features are also disclosed.

### BACKGROUND

### Technical Field

The present disclosure relates generally to distributed data storage systems.

### Description of the Background Art

With the increasing amount of data is being created, there is increasing demand for data storage solutions. Storing data using a cloud storage service is a solution that is growing in popularity. A cloud storage service may be publicly-available or private to a particular enterprise or organization. Popular public cloud storage services include Amazon S3™, the Google File System™, and the OpenStack Object Storage (Swift) System™.

Cloud storage systems may provide “get” and “put” access to objects, where an object includes a payload of data being stored. The payload of an object may be stored in parts referred to as “chunks”. Using chunks enables the parallel transfer of the payload and allows the payload of a single large object to be spread over multiple storage servers.

### SUMMARY

The present disclosure provides a system and method to perform access control authentication using a cryptographic hash of the encoding of access control rules. The compact cryptographic hash identifier of the access control rules is suitable for inclusion in a name index entry, whereas inclusion of the full encoding would result in a large name index entry, resulting in disadvantageously large storage requirements and bandwidth usage. In accordance with an embodiment of the invention, a common manifest is used to store and access versions of a named object stored in a distributed data storage system. The common manifest for the named object may encode a set of key-value metadata pairs which have been inherited from a parent object, such as an enclosing folder, for example.

The presently-disclosed solution may encode the access control policy as a list (ACL) of key-value pairs which may be encoded as part of an object version specific metadata chunk, or in a separate chunk that encodes inherited metadata (which is most likely the access control list) or in a chunk that is explicitly for the access control rules.

Encoding common key-value pairs in a common manifest (rather than in the individual version manifests) allows the entire set of common metadata to be identified by a single integer—the cryptographic hash of the full set of common metadata. This encoding also advantageously reduces the total disk space required to encode those pairs. Furthermore, to system bandwidth may be substantially reduced due to substantially reduced fetch operations to retrieve the common metadata; once the common manifest is retrieved for one version of a named object, the common manifest need not be retrieved again for other versions of the named object or for related objects (such as a parent object to the named object or a child object of the named object).

The distributed data storage system may include: a storage network; a plurality of storage servers accessed by a storage network; a plurality of clients; and a gateway server that is used by a plurality of clients the distributed data storage system. A global name index is stored in the distributed data storage system, wherein an entry in the global name index may include a name hash identifier, a unique version identifier, a version manifest content hash identifier, a generation number, and a common manifest content hash identifier. The common manifest content hash identifier identifies a common manifest for the named object. The common manifest encodes a set of key-value metadata pairs that are inherited from a parent object.

A client may initiate a put transaction by sending a request to the gateway server to put a new version of a named object into the distributed data storage system. The gateway server may access the namespace manifest for the named object that is stored in the distribution system so as to obtain at least the generation number for the current version manifest and the common manifest content hash identifier.

Unlike the creation of an enumerator in a name index for recording every possible access control policy, the use of a cryptographic hash to represent each policy places no prior constraints on the possible set of access control policies. Advantageously, this method of tokening the access control policy is compatible with any method of encoding the access control rules and is indifferent to the number of rules required for a given policy.

Other embodiments, aspects and features are also disclosed.

### BRIEF DESCRIPTION OF THE DRAWINGS

FIG. 1 depicts components of a distributed data storage system in accordance with an embodiment of the invention.

FIG. 2 is a flow chart of a method of putting a new version of an object to a distributed data storage system using a common manifest in accordance with an embodiment of the invention.

FIG. 3A depicts an exemplary implementation of a name indexing subsystem that uses a distributed name index in accordance with an embodiment of the invention.

FIG. 3B depicts an exemplary implementation of a name indexing subsystem that uses a namespace manifest in accordance with an embodiment of the invention.

FIG. 4 depicts a simplified illustration of a computer apparatus that may be utilized as a client or a server of the storage system in accordance with an embodiment of the invention.

FIG. 5 relates to an exemplary method for putting a new version of a named object to a distributed data storage system in accordance with an embodiment of the invention.

### DETAILED DESCRIPTION

To meet the increasing demands to scale out storage, storage clusters may utilize distributed metadata. However, using distributed metadata conflicts with user expectations of flexible access control.

Access control metadata is typically applied to large sets of files/objects, frequently matching the span of hierarchical directories. The Access Control Lists (ACLs) specify access rules for all files/objects within /Tenant/A/B/C, for example, where /Tenant is the directory of the corporation or other tenant of the storage cluster, /Tenant/A is a subdirectory of /Tenant, /Tenant/A/B is a subdirectory of /Tenant/A, and Tenant/A/B/C is a subdirectory of /Tenant/A/B.

More conventional storage systems with centralized metadata may efficiently cache the access control metadata for the more popular enclosing folders. Since there are typically relatively few top level directories, the storage server may utilize the cached access control metadata for a top level directory (for example, /Tenant) for subdirectories of the top level directory.

With distributed metadata, however, the metadata for directories “/Tenant/A/B/” and “/Tenant//A/B/C/” may be assigned to different metadata servers. Hence, determining whether or not a client is authorized to access files in different subdirectories under a top level directory may require communicating with many different metadata servers.

The presently-disclosed solution seeks to improve access control checking for distributed storage systems, particularly for distributed storage systems that use hash identifiers for payload and metadata chunks and which support some form global name indexing. Such storage solutions include scale-out NAS (network attached storage) services and object clusters. What is needed is a method of encoding Access Control policies which is compatible with distributed metadata, and requires only minor extra storage within a naming index, but does not limit the complexity of access control encoding.

An embodiment of the present invention relates to a method of encoding access control lists (ACLs) into a compact identifier that may be included in a master index (i.e. a global name index). Such a compact identifier advantageously allows even complex access control rules to be applied without requiring fetching bulky rules, at least in the vast majority of authorization checks.

In the solution disclosed herein, common metadata key-value pairs are encoded as a key-value metadata pair themselves, referencing a chunk holding the common metadata pairs. As disclosed herein, this encoding technique will typically reduce the number of accesses required for transactions that must evaluate the common metadata fields.

With or without the optimization of the presently-disclosed solution, authenticating a proposed transaction requires the following steps:

A first step involves searching for the relevant object name in a distributed name index. This search will likely yield a reference to the metadata describing the current object version and governing creation of new versions.

Without the presently-disclosed solution, the initiator (i.e. the initiating client) must fetch this metadata in order to determine whether the transaction is allowed. However, with the presently-disclosed solution, the Common Manifest Content Hash Identifier (CommonM-CHID) may be used to identify a specific policy encoded in the referenced metadata. The cryptographic hash function will guarantee that if the initiator has this metadata cached, then this cached metadata is valid. There is no risk of stale or misdirected metadata, allowing the cached metadata to be used to authenticate the proposed transaction.

Typically, there are phenomenally fewer distinct access control policies than object versions or even parent directories. Even if there are billions of object versions and millions of parent directories, the number of distinct access control policies will quite likely be below ten, and almost certainly below 100. The probability that the chunk encoding the common metadata will be cached is therefore very high, even if the caching algorithms are not told to favor common manifest metadata.

Identifying the access control policies by a cryptographic hash of the common metadata encoding the policies advantageously allows easy identification when the referenced policy is already encoded, avoids any concerns about having an outdated version of the policy, and even prevents attempts to evade the access control checks by attempting to trick the caching logic.

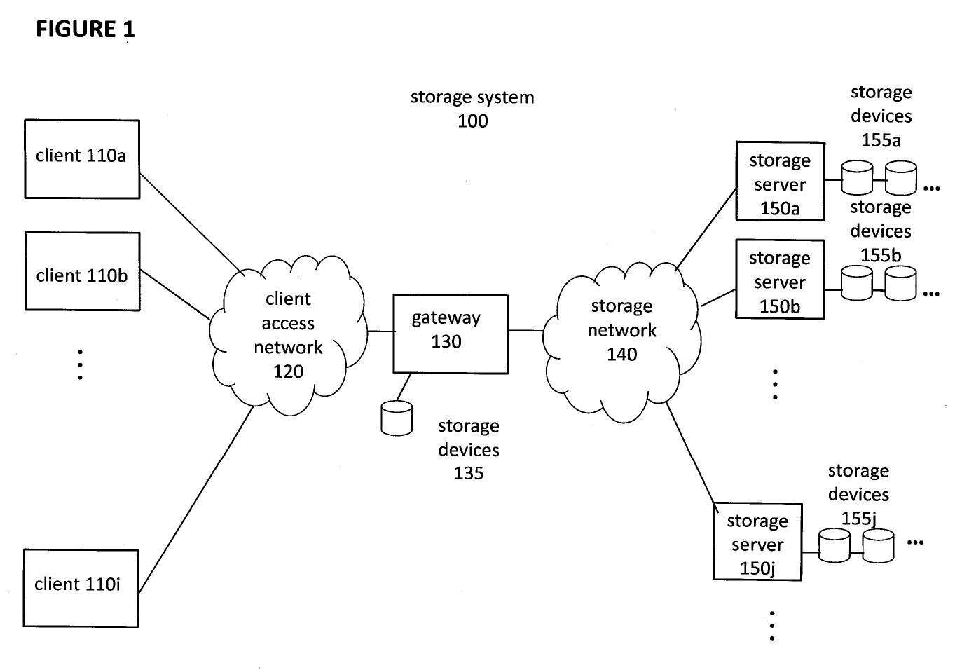

FIG. 1 depicts components of a distributed data storage system 100 in accordance with an embodiment of the invention. The system 100 includes client computers 110a, 110b, . . . , 110i (where i is any integer value), each of which may access gateway 130 via client access network 120. While one gateway and one client access network are depicted, the system may be accessed by way of multiple gateways and client access networks.

As further depicted, gateway 130 accesses storage servers 150a, 150b, . . . , 150j (where j is any integer value) via storage network 140. Each of the storage servers 150a, 150b, . . . , 150j may utilize, respectively, one or more storage devices 155a, 155b, . . . , 155j. In an exemplary implementation, the storage network 140 may utilize the Replicast protocol available from Nexenta Systems, Inc. of Santa Clara, Calif. Other protocols may be used.

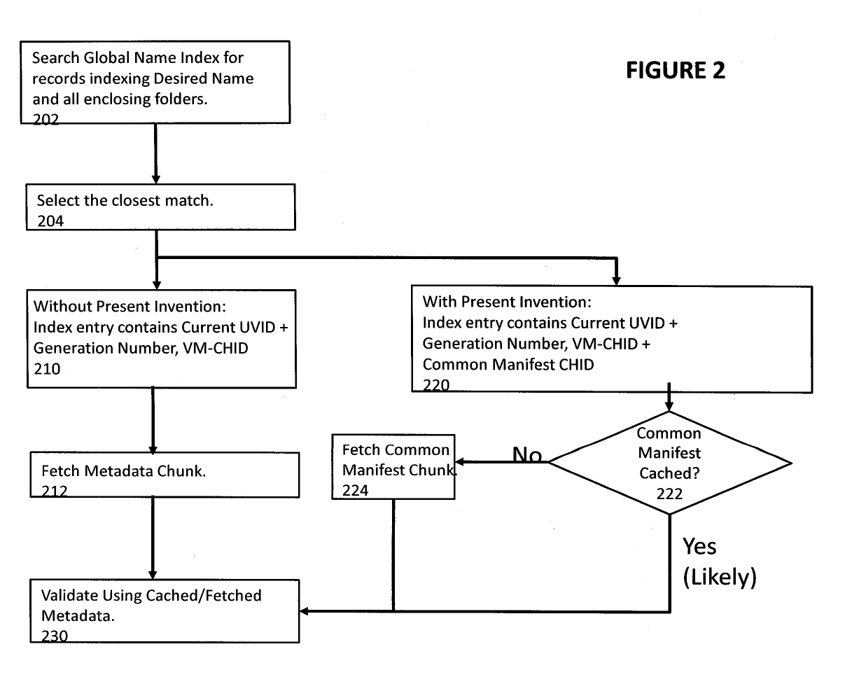

FIG. 2 is a flow chart that provides an illustration that compares a method for authorizing an action on an object or a folder with and without the present invention.

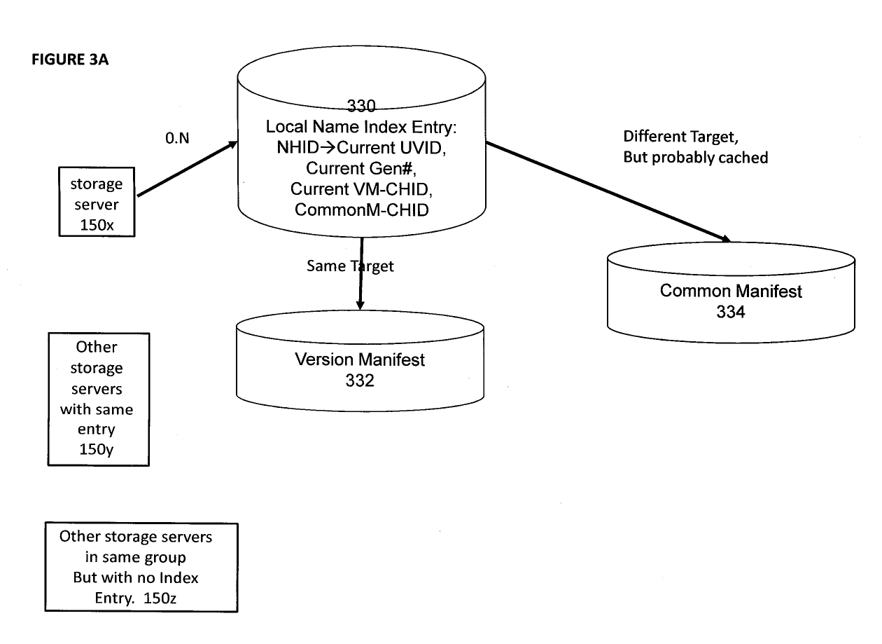

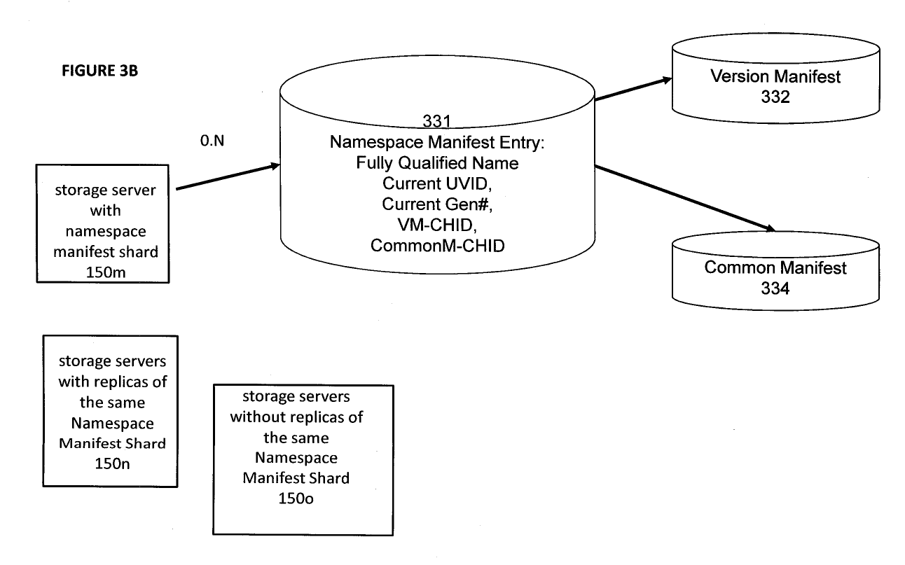

The method starts per block 202 with a search of a global name index for the target name and all enclosing folders. This search may be implemented with one of various conventional methods for maintaining and searching such an index which are compatible with the presently-disclosed solution. An exemplary implementation uses a namespace manifest as depicted in FIG. 3B when the search must find exact matches, non-current versions and/or enclosing folders, and uses a distributed name index accessed with a multicast search as depicted in FIG. 3A when only the current version of a specific object must be found.

Per block 204, the best result of the search, being the object itself or the longest prefix match for a folder object is selected.

Per block 210, without the presently-disclosed solution, the found index entry would include the unique identifier of the current object version (Current UVID), the Generation Number, and the content hash identifier of the version manifest (VM-CHID). In this case, per block 212, the VM-CHID must be used to fetch the metadata chunk, and the operation may then be validated using the fetched authorization metadata per block 230.

However, per block 220, with the presently-disclosed solution, the index entry is extended to also contain the content hash identifier of a common manifest (CommonM-CHID). Per block 222, the initiator then checks to see if the chunk holding the common manifest is cached.

The presently-disclosed solution is optimized for storage clusters where there will be relatively few distinct access control policies (less than a hundred, frequently less than 10). In such environments, the probability that the desired access control metadata chunk (in the form of a common manifest chunk) will already be cached is very high. If the desired access control metadata chunk is not cached, then that chunk must be fetched per block 224. This unlikely result ends up doing the same amount of work as without the optimization, while eliminating the fetch most of the time. A much more likely result is that the desired access control metadata chunk is cached. In either case, per block 230, the operation may be validated using the cached/fetched authorization metadata.

The presently-disclosed solution involves a name indexing subsystem that can provide information about object versions given the name of the object. The presently-disclosed solution extends the name indexing subsystem so that a query based upon an object name will return at least the following:

1. A unique identifier of the current object version matching the name. This is referred to as the “Current UVID” in the preferred implementation, where the “UVID” is the Unique Version Identifier. In the preferred embodiment, the UVID consists of a high-resolution timestamp extended by the transaction source network identifier to provide a globally unique timestamp. However, the presently-disclosed solution is compatible with other forms of a version identifier.

2. A unique identifier of the version manifest for this object version, or the VM-CHID which stands for the Version Manifest Content Hash Identifier. This identifier must never refer to any content other than the content originally put when this identifier was generated. In a preferred embodiment, this is a cryptographic hash of the content of the version manifest.

3. An identifier of the common manifest in the same format, referred to as the Common Manifest CHID. In a preferred embodiment, this is a cryptographic hash of the content of the common manifest.

4. A generation number, which is one greater than the largest generation number for this object which the transaction initiator was aware of when it put the object version.

FIG. 3A depicts an exemplary implementation of a name indexing subsystem that uses a distributed name index in accordance with an embodiment of the invention. Each storage server in the name indexing subsystem may function as a node of the name indexing subsystem and so may store name index entries.

Depicted in FIG. 3A are storage servers (150x, 150y, 150z) in a negotiating group for a named object, where the negotiating group may be determined by the NHID for the object. The name index entry 330 for an example object is depicted. The name index entry 330 may be locally stored at some of the storage servers within a negotiating group (in this example, storage server 150x and other storage serves 150y), but not at others (in this example, other storage servers 150z)

As shown, the name index entry 330 includes a name hash identifier (NHID) and a current unique version identifier (UVID). The NHID may be a cryptographic hash of the name of the object to uniquely identify the object, and the current UVID may include a high-resolution timestamp (generated when the version is put to the distributed storage system, for example) to uniquely identify a current version of the object. The name index entry 330 may also include a current generation number (Gen#), a current version manifest CHID (current VM-CHID) and a common manifest CHID (CommonM-CHID). The current VM-CHID may be implemented as a cryptographic hash of the contents of the current version manifest for the object version, and the CommonM-CHID may be implemented as a cryptographic hash of the contents of the common manifest for a group of objects that include this object.

Consider that the storage server 150x may receive a request for the name index entry for the target object. If the local name index has an entry for that same target object, then the current VM-CHID may be used to obtain the metadata chunk containing the current version manifest 332 of the target object. On the other hand, if the local name index does not have an entry for that same target object, then the CommonM-CHID may be used to obtain the metadata chunk containing the common manifest 334 of the target object, which is probably stored in the cache of the storage server 150x.

FIG. 3B depicts an exemplary implementation of name indexing subsystem that uses a namespace manifest in accordance with an embodiment of the invention. Depicted in FIG. 3B are storage servers (150m, 150n, 150o), where each storage server may function as a node of the name indexing subsystem that stores name manifest shards. Each namespace shard contains a subset of the namespace manifest entries (records) in the name indexing system. An example of a name manifest entry 331 within a shard is depicted. The example name manifest entry 331 may be within a name manifest shard that is locally stored at some of the storage servers (in this example, storage server 150m and other storage serves 150n), but not at others (in this example, other storage servers 150o)

As shown, the namespace manifest entry (an entry of the name indexing subsystem) 331 includes a fully-qualified name of the object and a current unique version identifier (UVID). The name manifest entry 331 also includes a current generation number (Gen#), a current version manifest CHID (current VM-CHID) and a common manifest CHID (CommonM-CHID).

Consider that the storage server 150m may receive a request for the namespace manifest entry for a target object. If the locally-stored namespace manifest shard has an entry for that same target object, then the current VM-CHID may be used to obtain the metadata chunk containing the current version manifest 332 of the target object. On the other hand, if the locally-stored namespace manifest shard does not have an entry for that same target object, then the CommonM-CHID may be used to obtain the metadata chunk containing the common manifest 334 of the target object, which is probably stored in the cache of the storage server 150m.

A version manifest specifies the payload for the object version and is used to encode a set of key-value metadata pairs for the object version. The payload specification may include inline payload but typically chunk references specifying the CHID (content hash Identifier) of the payload chunk and its offset and logical length within the object. The VM-CHID may be formed by applying a cryptographic hash to the contents of the version manifest chunk (VM Chunk).

A common manifest is used to encode a set of key-value metadata pairs which have been inherited from a parent object, such as an enclosing folder, for example. The CommonM-CHID may be formed by applying a cryptographic hash to the contents of a corresponding common manifest chunk (CommonM Chunk).

It should be noted that when the common manifest is identified by a cryptographic hash of its content, then any two object versions sharing the same common metadata (in the same sorted order) will reference the same common manifest CHID. Inheritance of access control from a parent directory will likely be the most common method for two objects to share the same common manifest, but two totally unrelated objects can share the same common metadata.

The use of a cryptographic hash is necessary to ensure that different key-value metadata sets will not produce the same CommonM Chunk even when an attacker is seeking to choose metadata for the specific purpose of colliding with existing chunks. If it were possible to create content with a desired CHID it would be possible to create a collision either obtaining read access to Common Manifests created by other users or pre-empting their content with the attacker supplied metadata. This would allow an attacker to bypass Access Control protections.

In one embodiment of the invention, the inherited key-value metadata in a common manifest may be used for an access control list (ACL). The ACL is a set of zero or more access control rules specifying rules to restrict operations on tenant objects for tenant users. A tenant may be a group of users who share access to a group of objects stored in the distributed data storage system. In an exemplary implementation, the access controlled may include the right to access version manifests, the right to expunge version manifests and/or the right to create new version manifests.

Encoding of the Common Manifest

In accordance with an embodiment of the invention, version manifests are prepared so as to enable the present invention's optimization of checking access control rules. The access control rules are preferably encoded in a metadata chunk that contains only the metadata entries related to access control. When there has been no access control specifications applied specifically to this object version, the access control rules are inherited from those specified for the enclosing folder. These are the same metadata rules that would have been referenced to authorize the transaction creating a new version manifest.

This base set of metadata in the version manifest includes one key-value pair which specifies this common manifest with a reserved key and the content hash identifier (CHID) of the common metadata as the value.

When the storage cluster prepares the index entry for the new version manifest, it extracts the common manifest's content hash identifier (CommonM-CHID) from the version manifest's metadata. The CommonM-CHID may be a mandatory metadata field which must be present for a new version manifest to be put. In the preferred implementation, there are already other mandatory metadata fields such as the fully-qualified name of the object, the unique version identifier for the object version, and the object version's creator and logical length.

Simplified Illustration of a Computer Apparatus

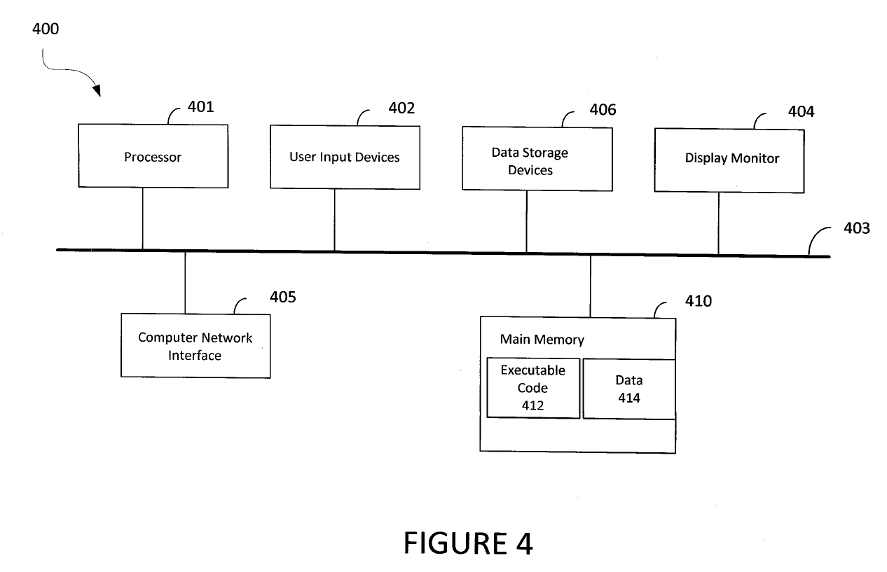

FIG. 4 is a simplified illustration of a computer apparatus that may be utilized as a client or a server of the storage system in accordance with an embodiment of the invention. This figure shows just one simplified example of such a computer. Many other types of computers may also be employed, such as multi-processor computers, for example.

As shown, the computer apparatus 400 may include a microprocessor (processor) 401. The computer apparatus 400 may have one or more buses 403 communicatively interconnecting its various components. The computer apparatus 400 may include one or more user input devices 402 (e.g., keyboard, mouse, etc.), a display monitor 404 (e.g., liquid crystal display, flat panel monitor, etc.), a computer network interface 405 (e.g., network adapter, modem), and a data storage system that may include one or more data storage devices 406 which may store data on a hard drive, semiconductor-based memory, optical disk, or other tangible non-transitory computer-readable storage media 407, and a main memory 410 which may be implemented using random access memory, for example.

In the example shown in this figure, the main memory 410 includes instruction code 412 and data 414. The instruction code 412 may comprise computer-readable program code (i.e., software) components which may be loaded from the tangible non-transitory computer-readable medium 407 of the data storage device 406 to the main memory 410 for execution by the processor 401. In particular, the instruction code 412 may be programmed to cause the computer apparatus 400 to perform the methods described herein.

Advantages of Identifying Access Control Policy with a Cryptographic Hash

It is possible to identify an access control policy with a name, or preferably with a name and a version. Such an identification may be readily made to be short enough to be included in a name index entry, and caching may be similarly optimized.

However, there are distinct advantages to using the cryptographic hash of the chunk payload, rather than a name (or a name and a version):
1) Performing a cryptographic hash on a metadata chunk may already be required with the underlying storage system.
2) A cryptographic hash uniquely identifies a given policy and may be used to authenticate that the image of the policy has not been altered. This prevents attacks on the authentication system by simply attacking the servers where the text of the policies is stored.
3) This strategy does not break if the number of access control policies changes. If the number of active policies is higher than anticipated, the effectiveness of pre-caching access control policies could be reduced. However, evolution of the policies does not impair the ability to encode new policies and then cache the new common metadata chunks. While historical access control policies may require an extra fetch when doing infrequent scans of old object versions, this should have very minimal impact on total system performance.

Exemplary Method to Put New Version of Named Object

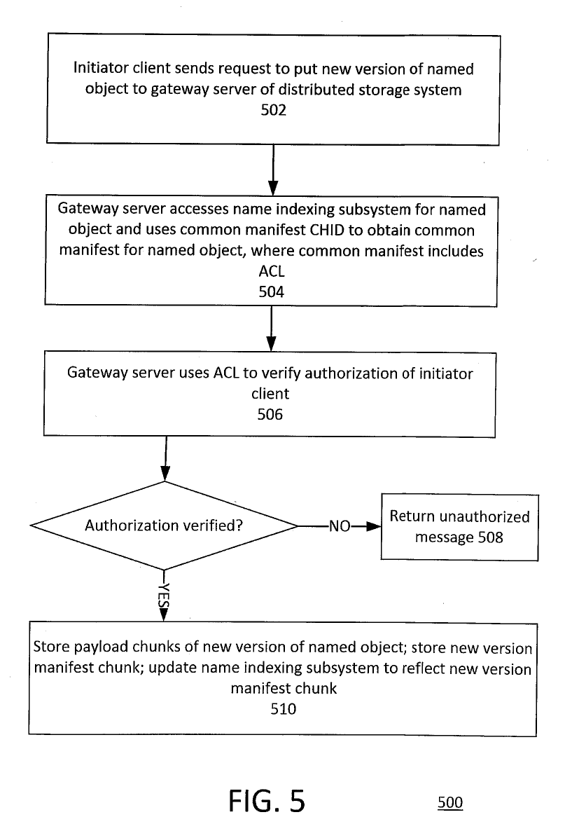

FIG. 5 relates to an exemplary method for putting a new version of a named object to a distributed data storage system in accordance with an embodiment of the invention. The method utilizes a name indexing system, wherein an entry in the name indexing subsystem includes at least a current version manifest content hash identifier and a common manifest content hash identifier.

In accordance with step 502 of this method 500, a client initiates a put transaction by sending a request to the gateway server to put a new version of a named object into the distributed data storage system. Per step 504, the gateway server accesses the name indexing subsystem for the named object that is stored in the distributed data storage system and uses the common manifest content hash identifier to obtain a common manifest for the named object. It is expected that the gateway server will most often be able to obtain the common manifest from a cached copy.

The common manifest may encode a set of key-value metadata pairs that are inherited from a parent object. In an exemplary implementation relating to this method 500, the parent object may be an enclosing folder of the named object, and the common manifest may encode an access control list for the parent object. In other implementations, the common manifest may encode other metadata, besides an access control list.

Per step 506, the gateway server may use the access control list to verify authorization of the initiator client to put the new version of the named object to the distributed data storage system. Per step 508, if authorization is not verified, then a message may be sent to the effect that the requested put is unauthorized. Per step 510, the gateway server, after verifying authorization, may: store payload chunks of the new version of the named object; store a new version manifest chunk; and update the name indexing subsystem to reflect the new version manifest chunk.

### EXEMPLARY EMBODIMENTS OF THE PRESENT INVENTION

### Embodiment 1

A system for accessing common metadata in a storage system with distributed metadata, the system comprising:

a name indexing subsystem storing entries that include an immutable reference to the common metadata; and

a plurality of nodes of the name indexing subsystem that cache the common metadata,

wherein the plurality of nodes are used to access the common metadata to validate authorization for storage actions, and

wherein the immutable reference is a cryptographic hash of the common metadata.

### Embodiment 2

The system of Embodiment 1, wherein the common metadata is stored in a common manifest that encodes a set of key-value metadata pairs.

### Embodiment 3

The system of Embodiment 1, wherein the common metadata is associated with an enclosing folder.

### Embodiment 4

The system of Embodiment 3, wherein the common metadata is inherited by folders and files contained within the enclosing folder.

### Embodiment 5

The system of Embodiment 4, wherein the common metadata encodes an access control list for the enclosing folder.

### Embodiment 6

The system of Embodiment 1, wherein the name indexing subsystem uniquely identifies a fully-qualified name and stores the entries of the name indexing subsystem in shards.

### Embodiment 7

A distributed data storage system comprising:

a storage network;

a plurality of storage servers accessed by a storage network;

a plurality of clients; and

a gateway server that is used by a plurality of clients to access the distributed data storage system,

a name indexing subsystem provided by the distributed data storage system,

wherein an entry in the name indexing subsystem includes at least a current version manifest content hash identifier and a common manifest content hash identifier.

### Embodiment 8

The system of Embodiment 7,

wherein a client initiates a put transaction by sending a request to the gateway server to put a new version of a named object into the distributed data storage system, and

wherein the gateway server accesses the name indexing subsystem for the named object that is stored in the distributed data storage system and uses the common manifest content hash identifier to obtain a common manifest for the named object.

### Embodiment 9

The system of Embodiment 8,

wherein the common manifest encodes a set of key-value metadata pairs that are inherited from a parent object.

### Embodiment 10

The system of Embodiment 9, wherein the parent object is an enclosing folder of the named object.

### Embodiment 11

The system of Embodiment 10, wherein the common manifest encodes an access control list for the parent object.

### Embodiment 12

The system of Embodiment 11, further comprising:

the gateway server using the access control list to verify authorization of the initiator client to put the new version of the named object to the distributed data storage system.

### Embodiment 13

The system of Embodiment 12, wherein the gateway server, after verifying authorization:

stores payload chunks of the new version of the named object;

stores a new version manifest chunk; and

updates the name indexing subsystem to reflect the new version manifest chunk.

### CONCLUSION

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc.

In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize. These modifications may be made to the invention in light of the above detailed description.

What is claimed is:

1. A system for accessing common metadata, metadata common to multiple object versions, in a storage system with distributed metadata, the system comprising:
a name indexing subsystem storing entries that include an immutable reference to the common metadata; and
a plurality of nodes of the name indexing subsystem that cache the common metadata,
wherein the plurality of nodes are used to access the common metadata to validate authorization for storage actions, and
wherein the immutable reference is a cryptographic hash of the common metadata.

2. The system of claim 1, wherein the common metadata is stored in a common manifest that encodes a set of key-value metadata pairs.

3. The system of claim 1, wherein the common metadata is associated with an enclosing folder.

4. The system of claim 3, wherein the common metadata is inherited by folders and files contained within the enclosing folder.

5. The system of claim 4, wherein the common metadata encodes an access control list for the enclosing folder.

6. The system of claim 1, wherein the name indexing subsystem uniquely identifies a fully-qualified name and stores the entries of the name indexing subsystem in shards.

7. A distributed data storage system comprising:
a storage network;
a plurality of storage servers accessed by a storage network;
a plurality of clients; and
a gateway server that is used by a plurality of clients to access the distributed data storage system,
a name indexing subsystem provided by the distributed data storage system,
wherein an entry in the name indexing subsystem includes at least a current version manifest content hash identifier and a common manifest content hash identifier.

8. The system of claim 7,
wherein a client initiates a put transaction by sending a request to the gateway server to put a new version of a named object into the distributed data storage system, and
wherein the gateway server accesses the name indexing subsystem for the named object that is stored in the distributed data storage system and uses the common manifest content hash identifier to obtain a common manifest for the named object.

9. The system of claim 8, wherein the common manifest encodes a set of key-value metadata pairs that may be inherited from a parent object.

10. The system of claim 9, wherein the parent object is an enclosing folder of the named object.

11. The system of claim 10, wherein the common manifest encodes an access control list for the parent object.

12. The system of claim 11, further comprising:
the gateway server using the access control list to verify authorization of the initiator client to put the new version of the named object to the distributed data storage system.

13. The system of claim 12, wherein the gateway server, after verifying authorization:
stores payload chunks of the new version of the named object;
stores a new version manifest chunk; and
updates the name indexing subsystem to reflect the new version of the new version manifest chunk.
